(19) United States
(12) Patent Application Publication
(10) Pub. No.: US 2016/0117453 A1
(43) Pub. Date: Apr. 28, 2016

(54) FULLY AUTOMATED MEDICAL CODING SOFTWARE

(71) Applicant: Richard Cales, Louisville, KY (US)

(72) Inventor: Richard Cales, Louisville, KY (US)

(21) Appl. No.: 14/921,850

(22) Filed: Oct. 23, 2015

Related U.S. Application Data
(60) Provisional application No. 62/067,510, filed on Oct. 23, 2014.

(51) Int. Cl. G06F 19/00

(52) U.S. Cl. CPC G06F 19/323

(57) ABSTRACT

A computer program for assigning medical evaluation and management codes describing a physician-patient encounter may include code adapted to detect a clinical setting parameter set by an act of the examining physician. The program may be further adapted to determine a first set of elemental clinical data fields corresponding to the clinical setting parameter. An electronic clinical form containing known-relevant elemental clinical data fields requiring input by the examining physician may be rendered. The program may eliminate data fields determined to be irrelevant. Pharmacy orders, lab orders, referrals, and/or any act of the examining physician relevant to determination of a medical evaluation and management code characterizing the physician-patient interaction may be recorded. Based on the foregoing acts and according to quantified risk, physical examination, and complexity of the physician-patient encounter a medical evaluation and management code may be assigned.

This application claims the benefit of U.S. Provisional Patent Application No. 62/067,510 filed on Oct. 23, 2014 and now pending, and said application is incorporated herein by reference in its entirety.

### I. BACKGROUND OF THE INVENTION

A. Field of Invention

Embodiments may generally relate to the field of automated medical coding.

B. Description of the Related Art

It is generally necessary to assign a medical evaluation and management code to doctor-patient encounters so that the physician may be compensated for his work. It is particularly important that these code assignments are accurate because inaccuracies would cause a physician to be either undercompensated or overcompensated, and thus may have serious economic consequences including insurer penalties for up-coding, and potential allegations of fraud. A variety of coding systems exist concurrently, including Common Procedural Terminology (CPT), Healthcare Common Procedure Coding System (HCPCS), and International Classification of Diseases (ICD) as well as a number of others. Additionally, each of the foregoing coding systems has gone through various revisions over the years. Presently, the process of manually assigning medical evaluation and management codes is sufficiently complex that specialized personnel must be utilized to interpret clinical data and properly assign a physician-encounter medical evaluation and management code.

More recently, computers have been used to partially automate the process of medical coding; however, even the most advanced systems still require medical coding professionals. In part, medical coding professionals are required to interpret and/or verify the accuracy of a physician's inputs. Some known systems use machine logic to make a best guess where data is lacking, unclear, or otherwise insufficient. Additionally, medical coding professionals remain a necessary part of the process of coding a patient encounter because the data required for arriving at the correct code must be obtained from disparate sources that are incompatible with the physician's electronic medical record keeping systems. For instance, it may be necessary to draw on data sources from other facilities to properly characterize the patient's medical history and these records may be in incompatible electronic formats, or may be stored on paper forms. Moreover, medical coding professionals also remain a necessary component of existing systems because of the possibility of so called up-coding, where an examining physician may exaggerate the work that was done thus driving up the fee. The current state of the art includes no mechanism for guarding against or limiting up-coding. What is missing in the art is a system that obviates the need for a medical coding professional to check a physician's inputs, or to assimilate data from incompatible external systems, and ensure that the correct medical evaluation and management code is assigned.

Some embodiments of the present invention may provide one or more benefits or advantages over the prior art.

### II. SUMMARY OF THE INVENTION

Some embodiments may relate to computer program for assigning medical evaluation and management codes describing a physician-patient encounter. Embodiments may include computer code adapted to detect a clinical setting parameter set by an act of the examining physician. The act may comprise initializing one of a plurality of complementary clinical computer programs. The program may be further adapted to determine a first set of elemental clinical data fields corresponding to the clinical setting parameter. This initial set may be regarded as potentially relevant to determination of a medical evaluation and management code characterizing a physician-patient interaction by virtue of the value of the clinical setting parameter. The program may be still further adapted to render an electronic clinical form containing known-relevant elemental clinical data fields requiring input by the examining physician. Elements may be determined to be relevant according to well established rules in the medical arts. Furthermore, embodiments may display further elemental clinical data fields on the electronic form, or a separate electronic form. And, one or more of the further elemental clinical data fields may have been found relevant based upon data input by the examining physician. Embodiments may also be adapted to eliminate elemental clinical data fields determined to be irrelevant to determination of a medical evaluation and management code characterizing the physician-patient interaction based upon input by the examining physician. Here too, relevancy or irrelevancy may be determined according to rules well established in the medical arts. Embodiments may be still further adapted to record pharmacy orders, lab orders, referrals, and/or any act of the examining physician relevant to determination of a medical evaluation and management code characterizing the physician-patient interaction. Finally, embodiments may include code adapted to assign a medical evaluation and management code according to quantified risk, physical examination, and complexity of the physician-patient encounter.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic diagram showing the relation of complementary programs to each other and a central server;

FIG. 2 is a conceptual drawing showing that the complementary programs may share code;

FIG. 3 is a logical diagram showing the relationship of clinical matter forms to clinical setting forms;

FIG. 4 is a drawing illustrating the general concept of a clinical matter form;

FIG. 5 is a drawing illustrating the an operational scheme of an embodiment;

FIG. 6 is a drawing illustrating a non-limiting example of a topology describing aspects of an embodiment; and

FIG. 7 is a drawing illustrating a non-limiting process of reducing the initial set of all possible data fields Uᵢ to a final set U_{f}.

### IV. DETAILED DESCRIPTION OF THE INVENTION

### A. Basic Definitions

As used herein the terms “embodiment”, “embodiments”, “some embodiments”, “other embodiments” and so on are not exclusive of one another. Except where there is an explicit statement to the contrary, all descriptions of the features and elements of the various embodiments disclosed herein may be combined in all operable combinations thereof.

Language used herein to describe process steps may include words such as “then” which suggest an order of operations; however, one skilled in the art will appreciate that the use of such terms is often a matter of convenience and does not necessarily limit the process being described to a particular order of steps.

Conjunctions and combinations of conjunctions (e.g. “and/or”) are used herein when reciting elements and characteristics of embodiments; however, unless specifically stated to the contrary or required by context, “and”, “or” and “and/or” are interchangeable and do not necessarily require every element of a list or only one element of a list to the exclusion of others.

The term binary is used herein in at least two ways that will be clear in context to one skilled in the art. Particularly, binary may refer to its common meaning in computer science indicating the binary number system of zeros and ones in which computer programs are encoded. However, this term, and the phrase “binary response”, is also used to describe a type of data input characterized by one of two possible responses that are generally either affirmative or negative such as yes/no, present/absent, true/false and so on.

The terms elemental clinical data field and elemental data field are used interchangeably herein to denominate data fields with which user interacts. The term elemental has been chosen to indicate that the field is a member of a set, and that it has no subsets.

Certain variable subscripts such as N and M may be used herein to describe, for instance, elements of a set or groups of parameters. Thus, depending on context, the subscripted variable, e.g. z_{N}, may refer to the elements of a set Z collectively, to an arbitrary element of the set Z, or to the N^{th} element of the set Z.

The term parameter is used herein in the sense commonly used in computer science to indicate a variable of a function to which logic is applied in order to generate a function output. The notation adopted herein for all parameters is the Greek letter pi (π) and the syntax that has been adopted is f(π) where “f” is a function to which the parameter π relates. For instance, FH(π) indicates a parameter of the function FH. Where a function has more than one parameter, an integer subscript is used to distinguish them. A variable subscript, e.g. N, may be used as described in the preceding paragraph according to the format FH(πT_{N}).

Certain mathematical symbols used herein, and while they all have their standard meanings, it is worth summarizing their meanings here because some may be unfamiliar. The following definitions are intended to be illustrative rather than limiting. ∀ means “for all”, as in “for all x” and is used to state a condition that applies to a given variable, e.g. “x”. Λ is the logical AND operator and has its ordinary meaning [symbol] is the logical OR operator and has its ordinary meaning. ⊃ indicates that one set is a proper subset of the other. For instance H⊃U indicates that the set H is a subset of U. ∪ indicates the union of two sets. For instance U=H∪P∪C means that U is the union of sets H, P and C. Braces { } are used herein to group the elements of a set.

The present Detailed Description is broken down in to sections for the sake of clarity. One will appreciate that headings should be understood as an illustrative convenience and not a limitation.

### B. Embodiments in General

Embodiments may comprise a set of complementary software programs that cooperatively cover all clinical settings and clinical matter types. These programs are intended for use in a plurality of clinical settings and are thus installable on a mobile computing device such as a tablet computer or handheld device. Embodiments of the invention encompass every possible datum necessary for assigning an accurate medical evaluation and management code. Embodiments may accomplish this in part by reducing clinical evaluation problems to discrete encounter-specific sets of data fields that can be filled by an examining physician with binary responses, e.g. in the negative or the affirmative. As used herein, the term encounter-specific means the data fields presented to the physician are filtered or otherwise limited to those which are relevant to establishing a medical evaluation and management code. Encounter specificity may be realized in part through the use of clinical setting forms and clinical matter forms, as will be described in more detail.

Physician inputs may be used by an embodiment to determine content and/or fields of a graphical user interface form(s) presented to the physician in any particular patient encounter. Thus, each patient encounter may have an automatically generated custom form(s) for documenting the encounter. Physician inputs that can be used for determining what data is relevant to a particular examination can include, the choice of program for documenting the encounter. For instance, if the physician should choose to initialize an emergency medicine application, then doing so may assign a value to a clinical setting parameter that reduces the universe of data that may be requested from the physician to those which are relevant to an emergency clinical setting. One skilled in the art will understand how to code for such a parameter, how to detect its value, and how to apply it to cause said reduction of the data. Further reduction or expansion of relevant data fields may take place as the physician inputs data documenting and characterizing the encounter. For instance, if the physician documents that the patient presents with a compound fracture of the left tibia, then the data fields presented to the physician will be limited to those which are relevant to documenting such a condition.

Since each of the set of complementary programs operates on a common standard using common code and data structures the data generated by one program may be operated upon by another without the necessity of translating the data through, for instance, a discrete software layer or through human interaction. Each of the cooperating software programs may share common code and may be characterized by the particular clinical setting form assigned to it. For instance, a program that is to be used in an outpatient setting would be customized with one clinical setting form while a program that is to be used in a nursing facility would be customized with another. The purpose of customization is to limit the data presented to the physician to that which is necessary for assigning a medical evaluation and management code.

Each program of the complementary set of programs may be specially adapted to a particular clinical setting. Thus, the programs are complementary in the sense that they collectively cover every possible clinical setting. Moreover, each of the complementary programs has the capacity to present to a user every possible data field necessary to assign an accurate medical evaluation and management code in the clinical setting to which the program is specially adapted.

Clinical matter forms are subsets of clinical setting forms. Each clinical matter form addresses a particular type of clinical matter such as a behavioral health exam; an eye, ear, nose and throat exam; or a neurologic exam. Furthermore, each clinical matter form is populated with fields that are calculated to encompass every possible response that bears on assigning a medical evaluation and management code. Each of the fields of the clinical matter forms may represent a query that may be answered by the physician with a binary response, e.g. in the negative or the affirmative. Therefore, the data inputs may be readily operated upon in real time by a medical coding algorithm without human interpretation.

Embodiments may include a data validation system whereby the physician may be presented with checkpoints during the examination process where he verifies the accuracy of his own inputs and/or inputs from other data sources. Accordingly, only the physician's professional judgment is necessary to check for errors. The physician's progress toward arriving at a medical evaluation and management code may be visually represented in real time using a progress bar or similar control which updates based upon a medical coding engine's calculation of the percentage of completion in calculating a medical evaluation and management code, and the percentage remaining.

### C. Medical Evaluation Coding Methodology

Embodiments may automatically assign a medical evaluation and management code according to physician inputs without the need for intervention or interpretation by a medical coding professional or any human. However, embodiments may include checkpoints where an examining physician may check his work in a convenient summary format. In part, this degree of automation is made possible by presenting the physician fields for supplying clinical data according to simple binary responses such as, without limitation, yes/no, present/absent, true/false, etc. Moreover, embodiments improve efficiency of the medical code assignment process carried out by a computer by presenting the examining physician with forms that are automatically limited to fields that are relevant to his clinical setting and pertaining to the medical matter type with which he is dealing. The following paragraphs illustrate the medical code assignment process.

Medical evaluation data fields for assigning medical evaluation and management codes are defined by embodiments of the invention as the union of three data sets, namely, a History set (H), Physical Examination set (P), and a Complexity set (C), i.e. U≡H∪P∪C (eq. 1). In this formulation the set of all data fields for assigning medical evaluation and management codes is the universal set U. The History set (H) is itself defined by three proper subsets, namely, the History of Present Illness set (I), the Review of Systems set (S), and the Past Family and Social History set (F). Accordingly, H⊃I, H⊃S, and H⊃F. Moreover, the History set (H) is the union of these three subsets, i.e. H≡I∪S∪F (eq. 2). Still further, each of the subsets I, S, and F are defined as sets of elemental clinical data fields, i.e. I≡{i_{N}}, S≡{s_{N}}, and F≡{f_{N}}. According to the presently described embodiment, the subsets I, S and F do not intersect; however, in other embodiments intersection may be permissible. The elemental data fields of each of the subsets I, S, and F correspond to clinical data that can be supplied in binary terms, e.g. yes/no, present/absent, etc. The cardinality of each of the subsets I, S, and F may vary from one embodiment to another; however, in the present embodiment the History of Present Illness subset (I) is cardinality eight, Review of Systems subset (S) is cardinality 14, and Past Family and Social History subset (F) is cardinality three. Accordingly, subset I contains eight data fields, subset R contains 14, and subset F contains three. For example, in the present embodiment, the eight elements of subset I are:

$$I = \{ \begin{matrix}Location , \\ Quality , \\ Severity , \\ Duration , \\ Time Course , \\ Context \\ Modifying Factors , \\ Symptoms\end{matrix} \} \qquad eq . 3$$

One skilled in the art will understand that the specific names of the elements of subset I, or any set or subset herein, may vary from one embodiment to another without departing from the scope of the invention. The meaning of the various elements of subset I are clear to those skilled in the medical arts and thus require no further explanation.

With continuing reference to subset I, each element of the subset corresponds to one of two numerical values depending on the input supplied by the examining physician. In general, an affirmative response is represented by the number one (1) and a negative response is represented by number zero (0). Importantly, a lack of a response is an indeterminate state and no medical evaluation and management code will be assigned until the missing data is supplied. In one embodiment a physician will be unable to advance further through the examination documentation process until all fields are supplied with responses. However, embodiments may also imply a negative response from a missing response, or may provide graphical user interface controls for providing all positive or all negative responses to a plurality of data fields.

Having supplied all fields of the subset I with clinical data, an embodiment may take the sum of the numerical values assigned to each response. Accordingly, in this embodiment subset I may correspond to a numerical value between zero (0) and eight (8) through the summation of eq. 4. In eq. 4 each i_{N} an element of subset I that has been assigned a number (0 or 1) corresponding to binary clinical data supplied by an examining physician:

$$I = {\sum }_{N = 1}^{8} {i}_{N} \qquad eq . 4$$

Moreover, subsets S and F are similarly defined by clinical data field elements and sums are similarly obtained by embodiments of the invention. Specifically, according to the present embodiment subset S is defined by the set of clinical data fields S_{N} and includes:

$$S = \{ \begin{matrix}Constitutional , \\ Eyes , \\ ENT , \\ Respiratory , \\ Cardiac , \\ Gastrointestinal , \\ Genitourinary , \\ Musculoskeletal , \\ Integument , \\ Neurologic , \\ Psychiatric , \\ Hematologic \text{-} Lymphatic , \\ Allergic \text{-} Immunologic , \\ Endocrine\end{matrix} \} \qquad eq . 5$$

Similar to subset I, the elements S_{N} of subset S correspond to binary response data supplied by an examining physician. Accordingly, each element S_{N} of subset S may be assigned a numerical value of either zero (0) or an integer greater than one indicating a corresponding number of symptoms. Thus, according to eq. 6 the subset S may be equated with a numerical value between zero and the cardinality of the subset, which in this instance is 14.

$$S = {\sum }_{N = 1}^{14} {s}_{N} \qquad eq . 6$$

Turning to subset F of the superset H, according to the present embodiment subset F is defined by the set of elemental clinical data fields f_{N} and includes:

$$F = \{ \begin{matrix}Past History \\ Family History \\ Social History\end{matrix} \} \qquad eq . 7$$

In one embodiment, each of the elements of subset F may be elemental data fields similar to those of subsets S and I. In such embodiments the elemental data fields are adapted to receive a binary response from the examining physician, e.g. yes/no, present absent, or true/false. Just as in subsets S and I, these elements may be readily assigned numerical values of zero or one depending on whether the corresponding response data is affirmative or negative. Thus, according to eq. 8 the subset F may be equated with a numerical value between zero and the cardinality of the subset, which in this instance is three.

$$F = {\sum }_{N = 1}^{3} {f}_{N} \qquad eq . 8$$

One skilled in the art will appreciate that the states of the elements of subset F, i.e. Past History, Family History, and Social History, depend on the states of the parameters π that describe each element. Thus the elements of subset F may each be formulated as logical functions. The logical functions may be carried out manually or automatically. If an embodiment leaves it to the physician to carry out the logical steps of the function then Past History, Family History, and Social History may comprise elemental clinical data fields where the physician sets the value of the field, i.e. the physician assigns a value to PH, FH, and/or SH. However, if an embodiment instructs a computer to carry out the logical steps of the function then Past History, Family History, and Social History are encoded as logical functions that return a value (zero or one) to f_{N} according to the states of their parameters π.

TABLE I
Partial List of Typical Parameters Describing PH, FH, and SH

| Past History (PH) | Family History (FH) | Social History (SH) |
|---|---|---|
| Illnesses | Heart disease | Alcohol use |
| Surgeries | Diabetes | Illegal drug use |
| Immunizations | Cancer | Smoking |
| Medications | High blood pressure | |
| Allergies | Stroke | |
| | Kidney disease | |
| | Arthritis | |
| | Osteoporosis | |
| | Alzheimer's | |
| | Alcoholism | |
| | Depression | |

According to embodiments where the elements of Subset F (Past History, Family History, and Social History) comprise elemental clinical data fields, the examining physician may be presented with non-interactive lists of the parameters π describing Past History PH(π_{N}), Family History FH(π_{N}), and Social History SH(π_{N}). If any of the parameters PH(π_{N}), FH(π_{N}), or SH(π_{N}) describing one of the elements (functions) PH, FH, or SH are affirmatively found by the examining physician then the element is marked by the physician in the affirmative. More rigorously stated, the logical relationship between an element of subset F, such as Family History (FH), and its parameters FH (π_{N}) is that FH is affirmative if any parameter of FH is affirmative. Or mathematically, FH=1 if FH(π₁) [symbol] FH(π₂) [symbol] . . . FH(π_{N})=1 else FH=0, where V is the logical OR operator. As used herein, the phrase “non-interactive list” refers to a list that is displayed to the examining physician, for example, as a static image. Thus, the physician can view the list but cannot change the state of, or assign values to, any of its elements. Furthermore, the members of a non-interactive list need not have an associated meaning, state, or value beyond a mere arrangement of pixels meaningful to a human viewer.

Alternatively, according to embodiments where the elements of subset F comprise encoded logical functions the examining physician would be presented with a set of clinical data fields corresponding to parameters π of the elements of subset F. Stated otherwise, the physician would be presented with a list of parameters corresponding to, for example, the Family History (FH) element of subset F, and this list of parameters FH(π_{N}) would be interactive. Thus, the physician could indicate with binary responses whether each parameter PH (π_{N}) is affirmative or negative. Similarly, lists of parameters would also be displayed corresponding to the Past History (PH) and Social History (SH) elements of subset F. A computer processor would then use the states of each parameter to determine the state of each of the three elements PH, FH, and SH using the associated logic of the function. Again, using FH as an illustrative example, the function logic is FH=1 if FH(π₁) [symbol] FH(π₂) [symbol] . . . FH (π_{N})=1 else FH=0. Having so determined the states of each of the elements PH, FH, and SH of subset F, a numerical value of F can be calculated with eq. 8.

At this point we have described how to calculate values for each of the elements of the History set H, i.e. values for subsets I, S and F. These values are used according to embodiments of the invention to determine a value for H using the assignment rules in Table II. For example, the first line of Table II indicates that H is equal to 4 if I is ≧4, S is ≧10, and F is ≧3. Stated more completely, H=4 if I≧4 [symbol] S≧10 [symbol] F≧3 else H=3 if I≧4 [symbol] S≧2 [symbol] F≧1 else H=2 if I≧1 [symbol] S≧1 [symbol] F≧0 else H=1 if I≧1 [symbol] S≧0 [symbol] F≧0 else H=0. The value of H so obtained is used later to assign a medical evaluation and management code as will be described in detail.

TABLE II
History Set H Evaluation Rules.

| H | I | S | F |
|---|---|---|---|
| 4 | ≧4 | ≧10 | ≧3 |
| 3 | ≧4 | ≧2 | ≧1 |
| 2 | ≧1 | ≧1 | ≧0 |
| 1 | ≧1 | ≧0 | ≧0 |

Turning now to the Physical Examination set (P), P is defined by a set of N elements p_{N} according to eq. 9 that each correspond to a system of the body to be examined. As used herein, depending on context, p_{N} may refer to the elements of P collectively (as in the preceding sentence), to an arbitrary element of P, or to the N^{th} element of P. According to the present formulation of P in eq. 10, the cardinality of P is 14; however, other embodiments may formulate this set differently depending upon varying conventions for combining some systems (e.g. the musculoskeletal system is sometimes divided into muscular and skeletal systems).

In general, the methodology for assigning values to the elements p_{N} is similar to that of the elements of subset F (i.e. PH, FH, and SH) above. Particularly, the physician examines each system p_{N}, and these systems may each be described by a number M of parameters p_{N}(π_{M}) indicating disease states in the system p_{N}. Thus, if any of the parameters p_{N}(π_{M}) are positively observed by the physician, then the system p_{N} is assessed an affirmative value. In symbolic terms, p_{N}=1 if p_{N}(π₁) [symbol] p_{N}(π₂) [symbol] . . . p_{N}(π_{M})=1 else p_{N}=0. Thus, similar to the elements of subset F, each element of the set P may be considered a logical function and may be similarly implemented either manually by presenting the physician with non-interactive lists, or automatically by encoding each element p_{N} as a function of its parameters p_{N}(π_{M}). Alternatively, the value of p_{N} may be the sum of its parameters p_{N}(π_{M}) where each parameter is assigned a value of zero or one depending on whether a problem is found.

$$\begin{matrix}P ≡ \{ \begin{matrix}{p}_{1} , \\ {p}_{2} , \\ {p}_{3} , \\ … \\ {p}_{N}\end{matrix} \} & eq . 9 \\ P = \{ \begin{matrix}Constitutional , \\ Eyes , \\ Ears \text{-} Nose \text{-} Throat , \\ Neck , \\ Respiratory , \\ Cardiovascular , \\ Chest ( breasts ) , \\ Gastrointestinal , \\ Genitourinary , \\ Musculoskelatal , \\ Integumentary , \\ Neurologic , \\ Psychiatric , \\ Hematologic \text{-} Lymphatic ,\end{matrix} \} & eq . 10\end{matrix}$$

Unlike other sets, we do not calculate a numerical value for P using a summation of its elements. Rather, P is divided into two subsets. One subset Pₛ includes all systems p_{N} having fewer than two systems with affirmative values, and the other subset P_{d} includes all systems p_{N} having two or more systems with affirmative values. Numerical values of the subsets Pₛ and P_{d} may then be obtained according to eq. 11 and 12, where p_{N} indicates an arbitrary function (body system) and π_{M} indicates all of the parameters of the arbitrary function (body system).

Pₛ=Σp_{N}∀p_{N} where Σp_{N}(π_{M})<2 eq. 11

P_{d}=Σp_{N}∀p_{N} where Σp_{N}(π_{M})≧2 eq. 12

Having calculated values for Pₛ and P_{d}, embodiments may then assign a value to the Physical Examination set P according to the rules set forth in Table III. For instance, P is assigned value 4 if Pₛ is any value and P_{d} is 9 or greater. Stated more completely, Table III can be summarized according to P=4 if Pₛ≧0 [symbol] P_{d}≧9 else P=4 if Pₛ≧12 [symbol] P_{d}<9 else P=2 if 11≧Pₛ≧6 [symbol] P_{d}<9 else P=1 if 5≧Pₛ≧1 [symbol] P_{d}<9 else P=0 if Pₛ=0 [symbol] P_{d}=0.

Table III. Physical Examination Set P Evaluation Rules

| P | Pₛ | P_{d} |
|---|---|---|
| 4 | ≧0 | ≧9 |
| 4 | ≧12 | <9 |
| 2 | 11 ≧ Pₛ ≧ 6 | <9 |
| 1 | 5 ≧ Pₛ ≧ 1 | <9 |
| 0 | 0 | 0 |

Turning now to the Complexity set C, which is the third and final set defining the Universal set U herein. Complexity C is defined herein as the set of three functions, Risk, Problem Points, and Data Points, i.e. C≡{R, PP, DP}. The data necessary for calculating R, PP, and DP is gathered during a medical examination, and their respective values depend on, for instance, the number of illnesses presently found in a patient, and their Severity and Course as defined herein. Severity is a variable the value of which is assigned by the examining physician during examination. Severity, can be mild, moderate, or severe as determined by the examining physician according the ordinary skill the medical arts. The Course variable can be set to improving, unchanged, or worsening, again, as assigned by the physician during examination according to the ordinary skill in the medical arts. By the completion of an examination the Course and Severity variables of each illness have been assigned one of the foregoing values, which may be represented according to any convenient data type, and not necessarily limited to strings or even the particular values set forth herein. In other words, equivalent terminology can be substituted for the foregoing values of Severity and Course without departing from the invention.

Risk (R) can have the values high, moderate, low, or minimal, and some embodiments may assign numerical values to these according to high(4), moderate(3), low(2), and minimal(1). R is assessed according the number of illnesses (IllnessNum) presently observed in a patient, and whether those illnesses are severe and/or worsening. For instance, if a patient is found to have two diagnosed illnesses in the present examination then the number of illnesses is two (IllnessNum=2). If any one of those illnesses has a Severity variable set to severe (Severity=“severe”), and any one illness has a Course variable set to worsening (Course=“worsening”), then R is assigned the value “moderate” or an equivalent value. An illustration of how an embodiment may assign values to Risk follows:
If Course=“worsening” and Severity=“severe” then R=high risk (4) else
If Course=“worsening” or IllnessNum≧2 then R=moderate (3) else
If IllnessNum≧2 and Course≠“worsening” and Severity≠“severe” the R=low (2) else R=minimal (1)

According to some embodiments the algorithm for assigning a value to R may include determining the number of illnesses, determining the maximum Severity among all of the illnesses (where severe is the maximum possible value and mild is the minimum), and the maximum Course variable among all of the illnesses (where worsening is the maximum possible value and improving is the minimum).

The Problem Points (PP) calculation comprises, according to some embodiments, a Boolean assessment of one or more variables describing whether a particular illness is self-limited, minor, established and stable/improving, established and worsening, new with no further work-up planned, or new with additional work-up planned. Each illness corresponds to a Problem P_{N}, and each Problem P_{N} is assigned a value between 1 and 4 inclusive. The maximum value among the set of all Problems P_{N} evaluated is assigned to the Problem Points PP variable. An illustration of the logic applied by an embodiment is as follows:
If ProblemStatus=“self-limited” then P_{N}=1 else
If ProblemStatus=“minor” then P_{N}=1 else
If ProblemStatus=“established and stable/improving” then P_{N}=1 else
If ProblemStatus=“established and worsening” then P_{N}=2
If ProblemStatus=“new with no further work-up planned” then P_{N}=3
If ProblemStatus=“new with additional work-up planned” then P_{N}=4
The embodiment then finds the largest value P_{N} and assigns it to the variable PP.

The Data Points (DP) calculation involves determining whether certain acts A_{N} have been taken in the course of an examination and assigning a numerical value to those acts A_{N}. The sum of the assigned values is then taken and assigned to the variable DP; however, according to some embodiments the value of DP may be capped at four (4). Records of whether the relevant acts have been taken exist in the form of variables stored within an embodiment. By way of illustration, a non-limiting example of how an embodiment may carry out this calculation is set forth here, wherein, a description of each act is used in concatenated form as the name of a true/false variable:
If OrderOrReviewClinicalLabTest=True then A₁=1 else A₁=0 and
If OrderOrReviewImaging=True then A₂=1 else A₂=0 and
If OrderOrReviewAncillaryServiceTest=True then A₃=1 else A₃=0 and
If DiscussTestWithPerformingPhysician=True then A₄=1 else A₄=0 and
If IndepReviewOfImageTracingOrSpecimen=True then A₅=2 else A₅=0 and
If DecisionToObtainOldRecords=True then A₆=1 else A₆=0 and
If ReviewAndSummationOfOldRecords=True then A₇=1 else A₇=0 and

$$DP = {\sum }_{N = 1}^{7} {A}_{N} such that 0 \leq DP \leq 4 \qquad eq . 13$$

Having calculated values for the functions R, PP, and DP, embodiments may then assign a value to the Complexity set C by sorting the three functions according to their values and selecting the middle value. If no middle value exists, then C equals the largest value among R, PP, and DP.

### D. Medical Evaluation and Management Coding Rules

The values assigned to the History H, Physical Examination P, and Complexity C sets in the preceding Section C are used by embodiments to assign a medical evaluation and management code. More specifically, the values of H, P, and C are combined with other variables that define the clinical setting and whether this is a first or follow-on encounter. For example, in one non-limiting embodiment the logic takes the following form:

OUTPATIENT (Office Care, Urgent Care)

If Template=New; else
99205: History≧4 and Physical≧4 and Complexity≧4; else
99204: History≧4 and Physical≧4 and Complexity≧3; else
99203: History≧3 and Physical≧3 and Complexity≧2; else
99202: History≧2 and Physical≧2 and Complexity≧1; else
99201: History≧1 and Physical≧1 and Complexity≧1; else
99999 (i.e. an error condition)

If Template=Established
99215: History≧4 and Physical≧4 and Complexity≧4; else
99214: History≧3 and Physical≧3 and Complexity≧3; else
99213: History≧2 and Physical≧2 and Complexity≧2; else
99212: History≧1 and Physical≧1 and Complexity≧1; else
99211

NURSING FACILITIES (Incl. Swing Beds)

If Template=Initial; else
99306: History≧4 and Physical≧4 and Complexity≧4; else
99305: History≧4 and Physical≧4 and Complexity≧3; else
99304: History≧3 and Physical≧3 and Complexity≧1; else
99999 (i.e. an error condition)

If Template=Subsequent; else
99310: History≧4 and Physical≧4 and Complexity≧4; else
99309: History≧3 and Physical≧3 and Complexity≧3; else
99308: History≧2 and Physical≧2 and Complexity≧2; else
99307: History≧1 and Physical≧1 and Complexity≧1; else
99999 (i.e. an error condition)

If Template=Annual; else
99318: History≧3 and Physical≧4 and Complexity≧2; else
99999 (i.e. an error condition)

If Template=Final
99316: ThirtyPlus=Yes; else
99315: ThirtyPlus=No; else
99999 (i.e. an error condition)

INPATIENT (Including Observation, Acute Care and Long-Term Acute Care)

If Template=Observation; else
If Type=SameDay; else
   99236: History≧4 and Physical≧4 and Complexity≧4; else
   99235: History≧4 and Physical≧4 and Complexity≧3; else
   99234: History≧3 and Physical≧3 and Complexity≧1; else
   99999 (i.e. an error condition)

If Type=DifferentDay; else
If SubType=Initial; else
   99220: History≧4 and Physical≧4 and Complexity≧4; else
   99219: History≧4 and Physical≧4 and Complexity≧3; else
   99218: History≧3 and Physical≧3 and Complexity≧1; else
   99999 (i.e. an error condition)
If SubType=Subsequent; else
   99226: History≧3 and Physical≧3 and Complexity≧4; else
   99225: History≧2 and Physical≧2 and Complexity≧3; else
   99224: History≧1 and Physical≧1 and Complexity≧1; else
   99999
If SubType=Final; else
   99217

If Template=Acute Care
If Type=Initial; else
   99223: History≧4 and Physical≧4 and Complexity≧4; else
   99222: History≧4 and Physical≧4 and Complexity≧3; else
   99221: History≧3 and Physical≧3 and Complexity≧1; else
   99999 (i.e. an error condition)
If Type=Subsequent; else
   99233: History≧3 and Physical≧3 and Complexity≧4; else
   99232: History≧2 and Physical≧2 and Complexity≧3; else
   99231: History+>1 and Physical≧1 and Complexity≧1; else
   99999 (i.e. an error condition)
If Type=Final
   99239: ThirtyPlus=Yes; else
   99238: ThirtyPlus=No; else
   99999 (i.e. an error condition)

Emergency Department
99285: History≧4 and Physical≧4 and Complexity≧4; else
99284: History≧3 and Physical≧3 and Complexity≧3; else
99283: History≧2 and Physical≧2 and Complexity≧3; else
99282: History≧2 and Physical≧2 and Complexity≧2; else
99281: History≧1 and Physical≧1 and Complexity≧1; else
99999 (i.e. an error condition)

Home Care

If Template=New; else
99345: History≧4 and Physical≧4 and Complexity≧4; else
99344: History≧4 and Physical≧4 and Complexity≧3; else
99343: History≧3 and Physical≧3 and Complexity≧3; else
99342: History≧2 and Physical≧2 and Complexity≧2; else
99341: History≧1 and Physical≧1 and Complexity≧1; else
99999 (i.e. an error condition)

If Template=Established
99350: History≧4 and Physical≧4 and Complexity≧3; else
99349: History≧3 and Physical≧3 and Complexity≧3; else
99348: History≧2 and Physical≧2 and Complexity≧2; else
99347: History≧1 and Physical≧1 and Complexity≧1; else
99999 (i.e. an error condition)

### E. Description of the Drawings

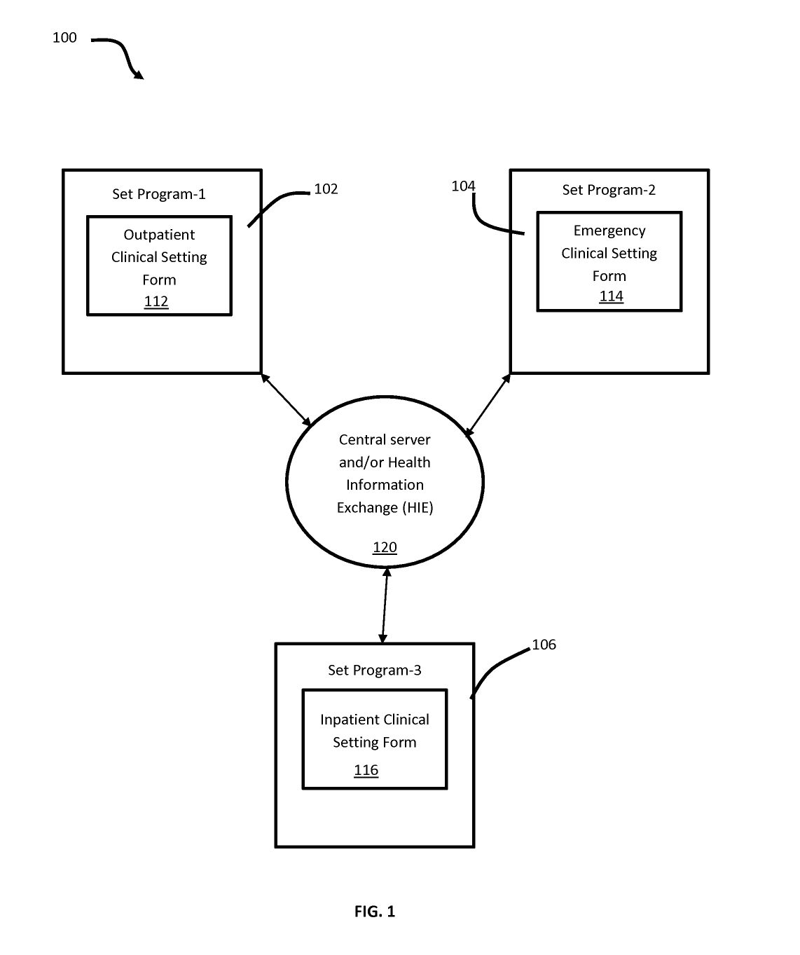

Referring now to the drawings wherein the showings are for purposes of illustrating embodiments of the invention only and not for purposes of limiting the same, FIG. 1 is a schematic diagram of a set of complementary cooperating software programs 100. For the sake of compact illustration, less than all of the clinical setting forms are represented in FIG. 1. A first program 102, Set Program-1, is specially configured with an outpatient clinical setting form 112. While Set Program-1 102 may include code for other clinical setting forms, only the outpatient clinical setting form 112 is active and thus characterizes Set Program-1. Similarly, Set Program-2 104 is characterized by an emergency clinical setting form 114, and Set Program-3 106 is characterized by an inpatient clinical setting form 116.

According to the embodiment 100 shown in FIG. 1 the several programs communicate through a centralized server, and/or health information exchange (HIE) server 120 through an intranet and/or the Internet. In some embodiments the HIE may be separate from the central server and may comprise a third party computer. Furthermore, the clinical setting forms that characterize the various programs, operate to narrow the sets H, P, and C to subsets thereof that are relevant to the particular clinical setting. Thus, a physician is only presented with elemental data fields that are relevant to the present clinical setting and matter at hand. In other words, a function of the clinical setting and matter forms is to eliminate or hide irrelevant fields.

It will be understood by those skilled in the art how one would code a form to achieve this functionality using known programming techniques. Furthermore, it will also be understood that the forms themselves do not necessarily contain the logic for performing the filtering function. Rather, filtering routines may be located outside of the form in a separate routine that may be on the local device, installed on a central server, or any other convenient arrangement known in the art. Furthermore, filtering or otherwise reducing the data fields presented to an examining physician to only those fields which are necessary for assigning a medical evaluation and management code decreases examination and computation time, and eliminates un-necessary network traffic.

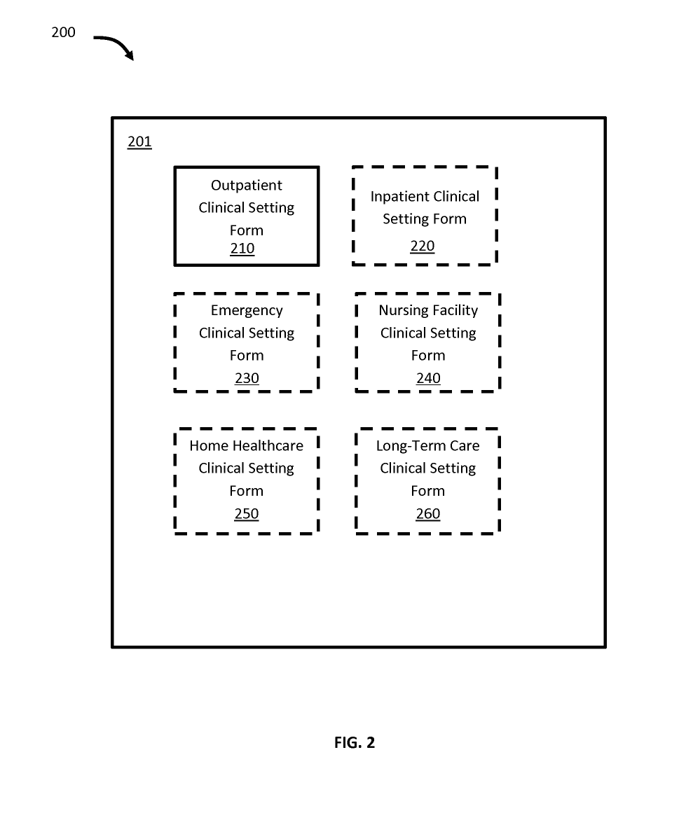

FIG. 2 illustrates the general concept that each of the complementary set of programs 200 may include identical or nearly identical code 201, but may have certain features activated while others are deactivated. As shown, the outpatient clinical setting form 210 is active and thus characterizes this particular set program as an outpatient program. However, the program 200 also includes an inpatient clinical setting form 220 as well as several others 230, 240, 250, and 260, or potentially the complete set of clinical setting forms. Accordingly, the nature of a given program may be determined by a particular configuration that may be activated, for instance and without limitation, at the time of installation. Encoding the program in this way enhances performance in part by ensuring continuity from one installation to another distributed across an enterprise system, meaning the code for one installation is identical or nearly identical to that of another even though they may differ in functionality and/or appearance at runtime. In this way coding errors can be more easily isolated and rectified and upgrades can more easily be produced.

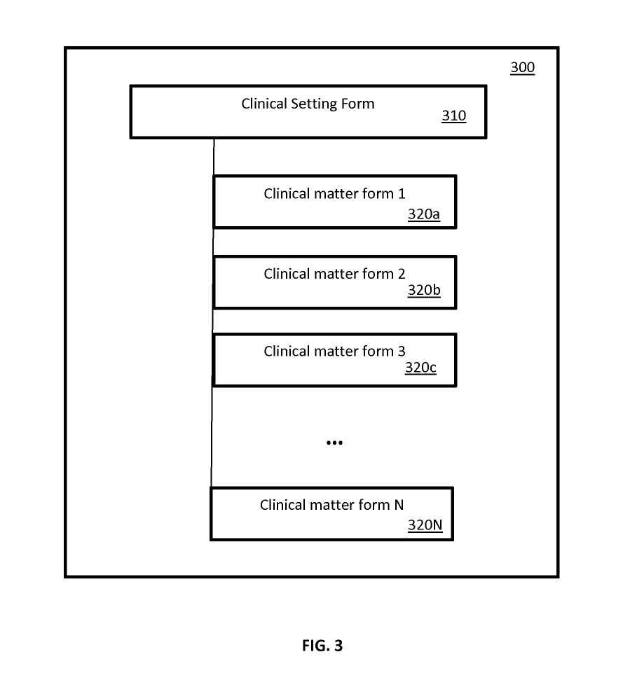

FIG. 3 illustrates the concept that clinical matter forms 320a, 320b, 320c . . . 320N are subsets of clinical setting forms 310. Collectively, the clinical setting and clinical matter forms characterize a given program of the set of complementary applications. In general, clinical setting forms characterize the setting in which the program is to be used, e.g. an outpatient, emergency, inpatient, long-term care, nursing facility, or home healthcare setting. However, certain types of clinical examinations may be conducted which may or may not be common to all clinical settings. Thus, each clinical setting is equipped with a relevant set of clinical matter forms which are calculated to cover the types of examinations that are expected to be conducted in a given clinical setting. Each clinical matter form 320a, 320b, 320c . . . 320N may itself branch out into subordinate forms for addressing particular clinical matter issues. For instance, an answer in the affirmative (or negative) to a particular query in clinical matter form 1 320a may require the physician to address one or more follow-up questions that otherwise would have been unnecessary. These follow-up questions may be placed on a branching form and the user may be returned to the parent form when he has completed answering the follow-up questions. It will be appreciated that any appropriate degree of branching is within the scope of the invention.

Alternatively, an embodiment may use the physician's input to generate a custom form, such as in real time during use of the form itself. For example, rather than the affirmative answer causing a branching out to another form, the present form may be dynamically re-generated and displayed with the follow-up question. Moreover, it will be understood that the clinical setting form and clinical matter forms, and/or their associated logic, function as a filter narrowing the sets H, P, and C into subsets that consist only of elemental clinical data fields relevant to the present examination. As noted above, an embodiment may assess that what is relevant to a given examination has changed during the examination based upon the physician's input. Thus, the universe of elemental clinical data fields may change during the examination and embodiments are adapted to account for the change and present the physician only with the relevant fields.

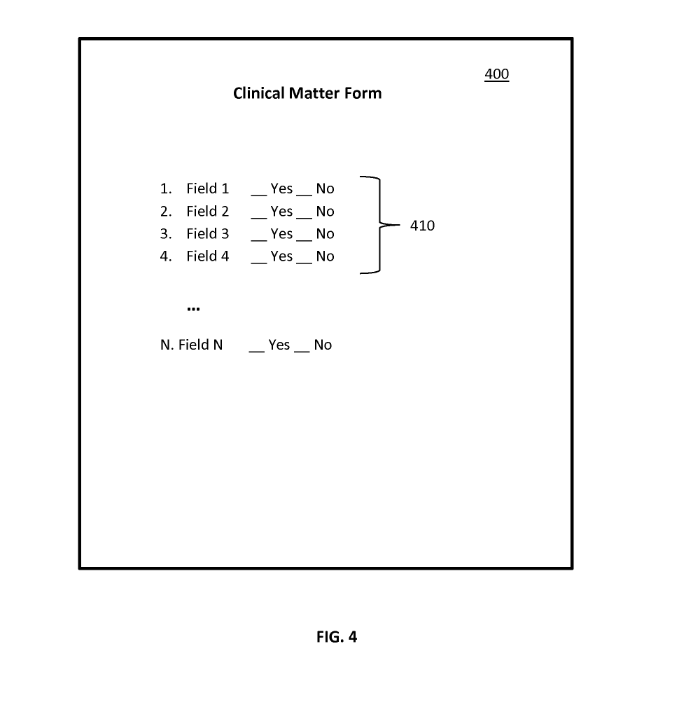

FIG. 4 illustrates the general concept of a clinical matter form 400. The form includes a plurality of queries 410, i.e. elemental clinical data fields, which can be answered with a binary response, e.g. yes or no, present or absent, or by providing a range of options in multiple choice format. Thus, the user-physician's inputs are sufficiently definite for a mathematical algorithm to operate upon them without the need for a human to interpret the data. Importantly, the clinical matter forms are specifically designed to encompass every possible elemental clinical data field that bears on calculating a medical evaluation and management code, while only presenting the physician with queries relevant to the present examination. Embodiments are adapted to accomplish this by accounting for the present clinical setting, pre-existing data on a given patient that may be stored on a central server, and inputs provided by the examining physician.

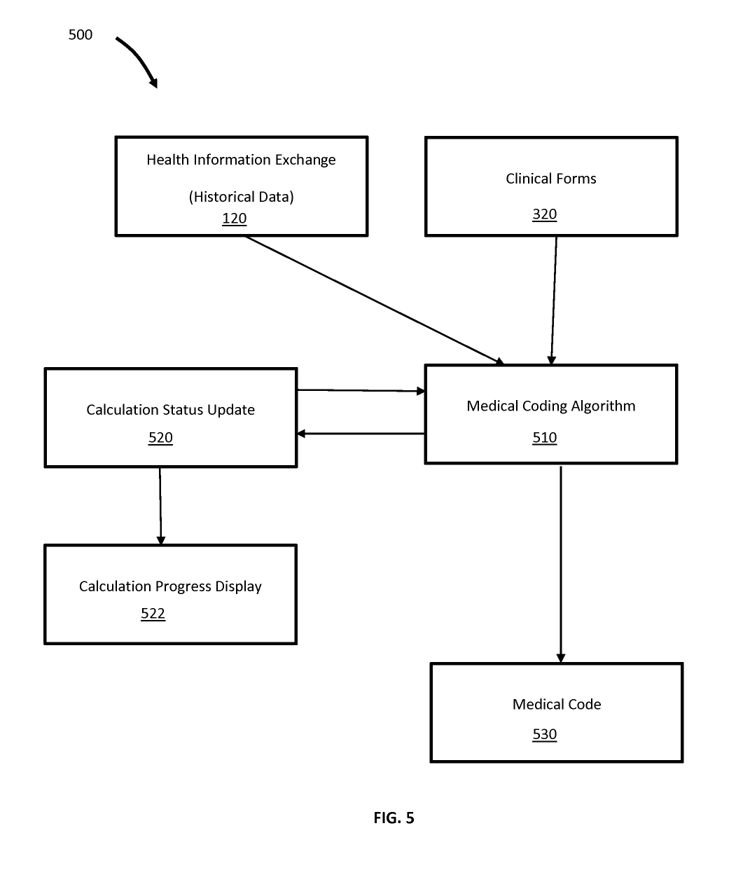

FIG. 5 illustrates an overall operational scheme 500 of an embodiment. As shown, one or more clinical forms 320 provide data regarding the present patient encounter; however, in order to correctly code the encounter the system must also account for the patient's historical data which may be provided in part by a remote health information exchange 120 as well as by the present examining physician through the clinical forms 320. The data provided by the clinical forms 320 and the health information exchange 120 is operated upon by a medical coding algorithm 510 which encompasses the logic described principally herein at Sections C and D.

Each time data is entered by the user-physician the algorithm may complete another step of the process for calculating a medical evaluation and management code. Thus, embodiments may recalculate the subset of U that is relevant to the present examination. Accordingly, each physician input can change the state of a program-embodiment in the sense that the program-embodiment can change the subset of relevant data fields, i.e. it may determine a new subset of U relevant to the present encounter as the examination progresses. Since embodiments may be aware of the number of data fields relevant to determining a medical evaluation and management code at any given time, and since the embodiment can discern fields containing data versus those which still require data, embodiments may be adapted to calculate the percentage of completion in assigning a medical evaluation and management code. Thus a calculation update routine 520 may determine a percentage completion and percentage remaining, and may display the progress graphically 522 for the user's reference.

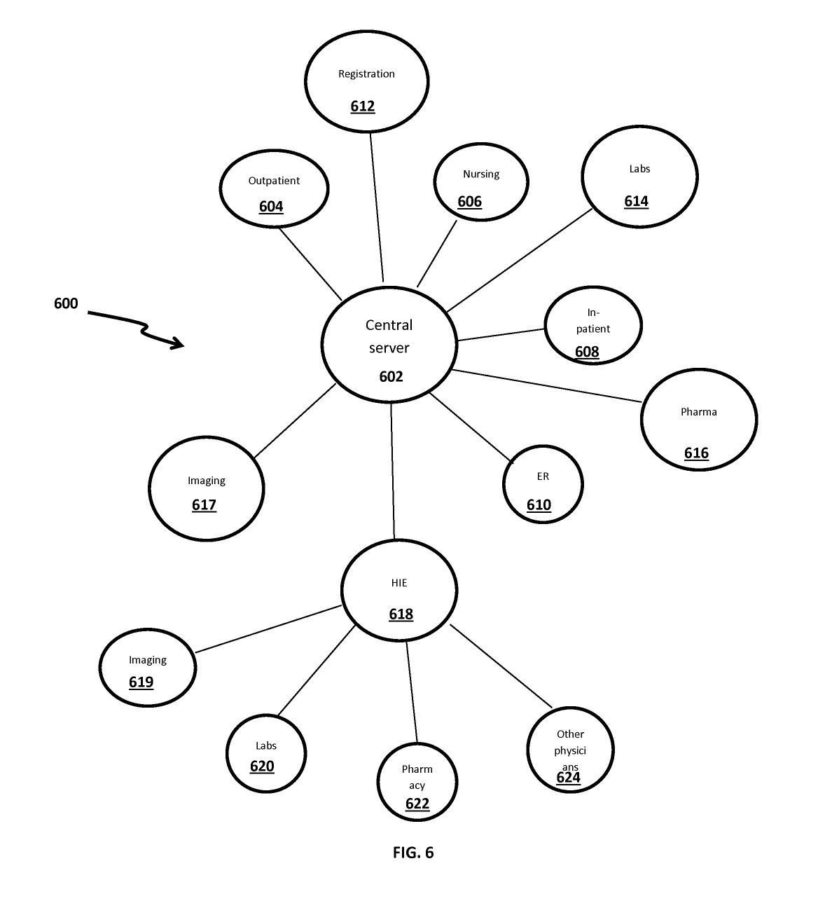

FIG. 6 illustrates a non-limiting example of a topology 600 describing aspects of an embodiment. The embodiment of FIG. 6 includes a central server 602 with which each of the complementary set of computer programs (604, 606, 610) is in data communication. Only three (604, 606, 610) of the set are illustrated for the sake of convenience; however, it will be understood that all of the programs covering the various clinical settings are communicatively connected in this way. The central server 602 is also in data communication with a registration desk 612. Thus, the embodiment can be updated with certain data collected at registration and this data can be communicated as needed to other nodes within the embodiment including, but not limited to, the complementary programs (604, 606, 610). Lab services 614 are also in data communication with the central server 602. There lab orders as well as results can be recorded and communicated back to the embodiment. This data can then be used in the Data Points calculation, as well as elsewhere in the embodiment, for calculating a medical evaluation and management code. Imaging services 617 are also connected to the central server 602 so that imaging orders can be recorded by embodiments, and imaging results can be retrieved and/or reviewed.

Additionally, a pharmacy 616 is in data communication with the central computer 602. Thus, prescriptions can be ordered by the physician during an examination and the act of doing so can be recorded automatically for the purpose, among other things, of generating an evaluation and management code. The pharmacy 616 shown here is likely the hospital pharmacy or a pharmacy with a close relationship to the examining physician because the pharmacy is shown in more or less direct communication. One skilled in the art will appreciate that the phrase direct connection may include cases where data must pass through intermediary computers and switches, etc.; however, what is important is that the pharmacy 616 is not communicating through a health information exchange 618.

Health information exchanges in general permit widespread sharing among entities that would otherwise not be in communication, such as between one hospital system and another. Accordingly, connecting the central server 602 to one or more health information exchanges 618 permits the embodiment to gather historical data on patients within their care that may have been generated elsewhere such as by imaging services 619, at outside labs 620, third party pharmacies 622, or other hospitals 624. This data can be gathered by the central server and populated in a clinical form displayed on and/or stored in one of the complementary programs (604, 606, 610). Moreover, the program (604, 606, or 610) may request data as the universe of relevant data fields changes through an examination.

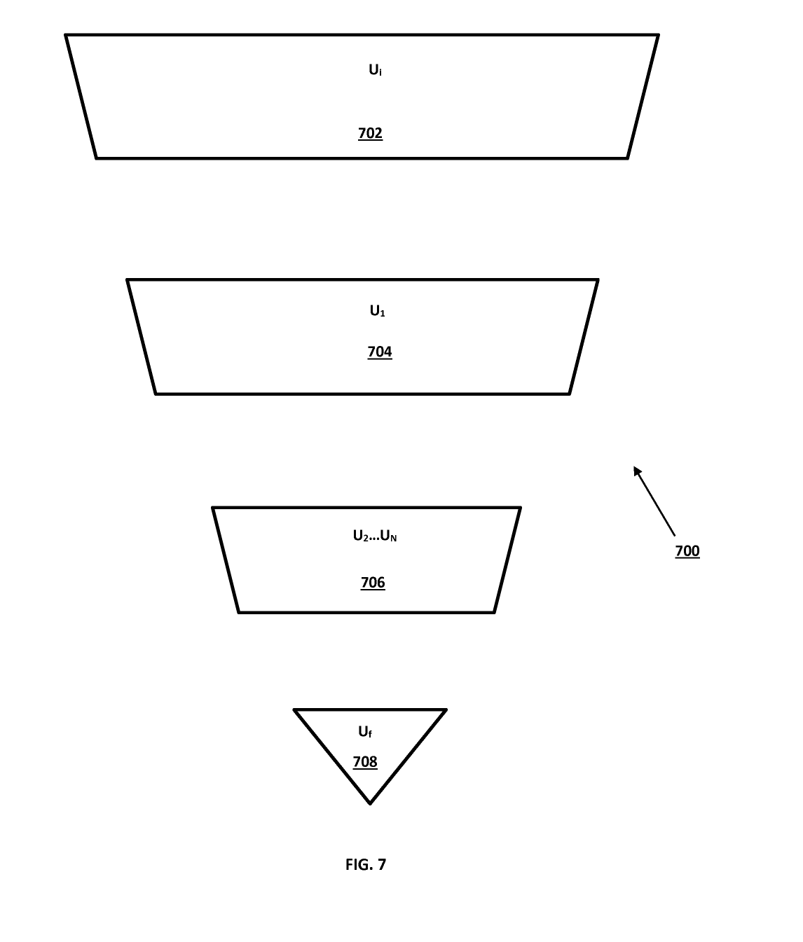

FIG. 7 illustrates a non-limiting process of reducing the initial set of all possible data fields Uᵢ to a final form U_{f} that represents only those fields which are relevant for assigning a medical evaluation and management code in the present case. The process begins at step 702 with all clinical data fields Uᵢ for possible inclusion in the final set U_{f}. In the next step 704, an examining physician selects one of the complementary set of computer programs by initializing, opening, or running the application. This act, or a similar act having the same effect, has the effect of assigning a value to a clinical setting parameter which indicates a first approximation of the relevant clinical data fields. At this point, some portion of the data fields will be known-relevant, others pertaining only to non-selected clinical settings will be determined irrelevant, and still others will be in an indeterminate state where they may or may not be relevant, pending physician inputs, but their relevancy has not yet been determined. Accordingly, the clinical setting parameter reduces the universe of potentially relevant data fields to those which characterize the selected application. For instance, if the application is the emergency medicine application, then only those data fields relevant to emergency medicine will be included in U₁. The known-relevant portion of U₁ may be presented to the physician on, for instance, an interactive electronic form. Those skilled in the medical arts will readily understand what these known relevant fields include.

In step 706, the physician begins interacting with the selected application perhaps by identifying the patient. They physician's interactions provide data to the embodiment that is relevant to assigning a code, and the physician's interactions also cause the embodiment to further limit the relevant data fields and to gather any pre-existing records that may contain data for one or more of the relevant data fields. Throughout this stage, the state of the program/embodiment continues to change as data is gathered from the physician and from remote sources, and as irrelevant fields are eliminated. Thus, the universe of potentially relevant clinical data fields continues to change U₂ . . . U_{N}. The number of potentially relevant fields may decrease, or increase if new illnesses are identified for evaluation. Thus fields may be included that were previously eliminated as irrelevant or indeterminate relevance. Accordingly, further clinical data fields may be displayed to the physician as their relevance is determined, and in view of a logical progression of an examination as will be apparent to those skilled in the art. The state of the program may also change during this time as labs are ordered and recorded, referrals are made to specialists, prescriptions are ordered, or as various other acts are taken by the physician and recorded in the embodiment.

Finally, in step 708 the set of relevant data fields has been fully reduced and identified U_{f}, and all of the necessary data has been supplied to those fields. The physician may be asked at this time, and possibly at various times throughout the process 700, to verify certain data inputs and results. Emphasis may be placed on particularly critical data that could result in an incorrect code. The embodiment operates on one or more of the data fields to ascertain a medical evaluation and management code according to the processes described herein. While certain of these operations may be carried out partially or iteratively throughout the examination to obtain intermediate values of U, H, P and C, this final step entails in a final operation returning a code.

The user-physician may also be presented with a data validation features where he checks his work thereby limiting error. For example, and without limitation, an input that is inconsistent with another input may trigger a warning or indication that the physician should verify his input. Embodiments may also prevent the physician from moving on to the next screen or step in the examination until all relevant inputs have been gathered. Embodiments may include a data summary screen, and may stress verification of data that has been deemed to have a high probability of error or for which an error would result in a high degree of damage to the patient and/or healthcare service provider.

It will be apparent to those skilled in the art that the above methods may be changed or modified without departing from the general scope of the invention. The invention is intended to include all such modifications and alterations insofar as they come within the scope of the appended claims or the equivalents thereof

Having thus described the invention, it is now claimed:

1. A co-operable set of computer programs for recording patient interactions, comprising a set of instructions, portions of which are executable on at least a mobile computing device, the co-operable set of computer programs being adapted to carry out the acts of:
detecting a clinical setting parameter, wherein the parameter value is set by an act of an examining physician comprising initializing one of a plurality of complementary clinical computer programs;
determining a first set of elemental clinical data fields corresponding to the clinical setting parameter that are potentially relevant to determination of a medical evaluation and management code characterizing a physician-patient interaction;
rendering an electronic clinical form containing known-relevant elemental clinical data fields requiring input by the examining physician;
displaying further elemental clinical data fields on the electronic form, or a separate electronic form, one or more of the further elemental clinical data fields being found relevant, based upon input by the examining physician, to determination of a medical evaluation and management code characterizing the physician-patient interaction;
eliminating elemental clinical data fields as irrelevant to determination of a medical evaluation and management code characterizing the physician-patient interaction based upon input by the examining physician;
recording pharmacy orders, lab orders, referrals, and/or any act of the examining physician relevant to determination of a medical evaluation and management code characterizing the physician-patient interaction; and
assigning a medical evaluation and management code according to quantified risk, physical examination, and complexity of the physician-patient encounter.

2. The co-operable set of computer programs of claim 1, wherein the step of determining a first set of elemental clinical data fields includes determining at least a portion of a universe of data fields to be relevant, a portion of the universe of data fields to be irrelevant, and a portion of the universe of data fields to have indeterminate relevance.

3. The co-operable set of computer programs of claim 1, wherein the step of rendering an electronic clinical form comprises a plurality of said renderings in time-series.

4. The co-operable set of computer programs of claim 3, wherein each of the renderings includes data fields calculated to further reduce the number of potentially relevant data fields.

5. The co-operable set of computer programs of claim 1, further comprising the step of forming a data communicative connection between a mobile computing device programmed with at least one of the co-operable set of computer programs and at least one central server.

6. The co-operable set of computer programs of claim 5, wherein the central server is adapted to forming data communicative connections between itself and one or more of a pharmacy computer system communicative with prescription records, a lab computer communicative with lab records, a registration computer communicative with patient registration records, and a medical imaging lab computer communicative with imaging records.

7. The co-operable set of computer programs of claim 1, further comprising the step of forming a data communicative connection between a central server and a healthcare information exchange.

8. The co-operable set of computer programs of claim 7, wherein the healthcare information exchange is communicative with data sources including one or more of a pharmacy computer system communicative with prescription records, a lab computer communicative with lab records, a hospital computer communicative with patient records, and a medical imaging lab computer communicative with imaging records.

9. The co-operable set of computer programs of claim 1, wherein the clinical setting parameter indicates one of an outpatient clinical setting, an in-patient clinical setting, an emergency clinical setting, a nursing facility clinical setting, a home healthcare clinical setting, or a long-term care clinical setting.

10. The co-operable set of computer programs of claim 1, wherein the value of a clinical setting parameter indicates the potential relevance of clinical data fields comprising clinical matters selected from one or more of a general medical examination; a behavioral health examination; a cardiac examination; a dermatologic examination; a digestive system examination; an eye, ear, nose and throat; a genitourinary examination; an injury/musculoskeletal examination; a neurologic examination; and a respiratory examination.

11. The co-operable set of computer programs of claim 1, wherein an elemental clinical field relates to a variable such that a datum entered into the elemental clinical data field may be translated into one of two values.

12. The co-operable set of computer programs of claim 1, wherein a medical coding algorithm operates upon inputs of the examining physician in real time to calculate a percent completion toward arriving at a medical evaluation and management code.

13. The co-operable set of computer programs of claim 12, wherein the percent completion depends upon a known number of steps completed and a known maximum number of steps remaining to be completed.

14. The co-operable set of computer programs of claim 13, wherein the percent completion is dynamically displayed to the examining physician and is updated as progress is made toward assigning a medical evaluation and management code.

15. The co-operable set of computer programs of claim 1, further comprising displaying a data validation screen wherein the examining physician checks the validity of his own input.

16. The co-operable set of computer programs of claim 1, further comprising the step of calculating a complexity as a function of Risk, Problem Points, and Data Points.

17. The co-operable set of computer programs of claim 16, wherein Risk is a function of the number of diagnosed illnesses of the patient, the severity of at least one illness of the patient, and the course of at least one illness of the patient.

18. The co-operable set of computer programs of claim 16, wherein Problem Points is a function of whether an illness is minor, whether an illness is established and stable or improving, whether an illness is established and worsening, whether an illness is new with no further workup planned, and whether an illness is new with additional workup planned.

19. The co-operable set of computer programs of claim 16, wherein Data Points is the sum of acts taken by the examining physician selected from one or more of ordering or reviewing clinical lab tests, ordering or reviewing imaging, ordering or reviewing ancillary service testing, discussing a test with a performing physician, independent review of imaging trace or specimen, a decision to obtain old records, and a review and summation of old records.

20. A progress indicator computer program comprising a set of instructions portions of which are executable on at least a touch-screen computing device and adapted to carry out the acts of:
rendering a dynamic visual indicator adapted to show the degree of completion of a medical billing code algorithm for calculating a medical billing code from data inputted by a user;
rendering at least one electronic clinical form having a predetermined set of fields, wherein each field corresponds to a variable of the medical billing code algorithm so that a datum entered by the user into a field of the set of fields may be operated upon by the medical billing code algorithm without further human interaction;
periodically calculating the degree of completion of the medical billing code calculation by the medical billing code algorithm; and
periodically adjusting the visual indicator to reflect a current degree of completion of the medical billing code calculation.
